(19) United States
(12) Patent Application Publication
(10) Pub. No.: US 2011/0289515 A1
(43) Pub. Date: Nov. 24, 2011

(54) GENERATING SERVICE-ACCESS ACTIVITIES FOR WORKFLOW APPLICATIONS

(75) Inventors: Au Ying Hung, Shanghai (CN); Min Liao, Shanghai (CN); Minmin Xue, Shanghai (CN)

(73) Assignee: Microsoft Corporation, Redmond, WA (US)

(21) Appl. No.: 12/783,070

(22) Filed: May 19, 2010

(51) Int. Cl. G06F 9/46; G06F 17/00; G06F 3/048

(52) U.S. Cl. 719/318; 715/769; 715/234

(57) ABSTRACT

The present invention extends to methods, systems, and computer program products for generating service-access activities for workflow applications. Embodiments of the invention automatically generate service-access activities based on (e.g., Web) service metadata. One-click generation, together with encapsulation of configuration complexity, helps developers improve productivity and reduce the likelihood of making mistakes.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In many computing environments, a collection of one or more connected (and possibly interdependent) tasks are represented in a workflow. A workflow can include a sequence of tasks, declared as work of a person, a group of persons, an organization of staff, or one or more simple or complex mechanisms. A workflow can be described using formal or informal flow diagramming techniques, showing directed flows between processing steps. In many cases, computers are used to assist in workflow generation. For example, application programs can provide graphical design surfaces to add, modify, and delete components and component connections within a workflow diagram.

Each component in a workflow diagram can be defined by at least three parameters: an input, transformation rules, and an output. Input to a workflow component is the data required to complete the task represented by the workflow component. Transformation rules (or algorithms) represent activities carried out by human roles and/or machines. Output from a workflow is provided as input to downstream workflow components. Thus, workflow components can be interconnected when the output of one previous (set of) component(s) is equal to the input requirements of a following component.

At least some application programs also permit a user to connect a workflow to existing external services. As such, a workflow developer can leverage the functionality of existing external services and is relieved from having to re-create the functionality provided by the existing external services. Once incorporated into a workflow, components within the workflow can interact with the external services to send input to and receive output from the external services.

However, configuring a workflow to interact with external services can be relatively complex. For example, an application developer is often required to perform a variety of different manual operations to configure a workflow to access an external service. On a graphical design surface, a workflow developer is typically required to drag and drop activities on the designer surface. The activities can include send components for implementing a one way communication operation and send and ReceiveReply components for implementing two communications. The workflow developer must then create a new configuration file to configure an endpoint and binding that the workflow can use to communicate with the external service.

Subsequently, any activities, such as, for example, send components and send and receive reply components, must also be configured to match all operations on the service contract for the external service. Configuring activities can include inputting an operation name and service contract name. Configuring activities can also include configuring data content for both input and output operation parameters. Configuration data content can be increasingly difficult when the data content is required to compose a message contract. Configuring activities can also include configuring operation settings, such as, for example, protection levels, serializer options, etc.

Additionally, a workflow is typically required to be re-configured to access an external service each time the external service is updated. As a result, configuration data is also typically required to be manually entered each time an external service is updated.

Accordingly, due to the general complexity of workflow configuration as well as significant manual entry of configuration data, configuring a workflow to access external services can be quite complicated and prone to user errors. These difficulties can be compounded when external services are regularly updated.

### BRIEF SUMMARY

The present invention extends to methods, systems, and computer program products for generating service-access activities for workflow applications. In some embodiments, a generated activity is configured to access an external service. An editor receives user input dragging and dropping a generated activity onto a workflow designer surface. The generated activity is for inclusion in a workflow. The editor receives additional user input defining operation input parameters and operation output parameters for invoking the external service.

Automatically and without further user input, the generated activity is configured to access the external service in response to the additional user input. Metadata defining the operation of the external service is accessed. A configuration file is generated in accordance with the retrieved metadata. The configuration file describes at least the address of the external service, how an endpoint for the external service is to be used, and how to access the external service.

A message type is generated to fit data format of the external service in accordance with the retrieved metadata. Message type generation includes, generating input expressions to convert input parameters from the generated activity into the message format for inclusion in send messages sent to the external service. Message type generation also includes, generating output expressions to convert reply messages in the message format received from the external service into output parameters for the generated activity. Service activities are corresponding to service operations of the external service are generated based on the generated message type.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates generating service-access activities for workflow applications.

FIG. 2 illustrates a flow chart of an example method for generating service-access activities for workflow applications.

FIG. 3 illustrates another example computer architecture that facilitates generating service-access activities for workflow applications.

### DETAILED DESCRIPTION

The present invention extends to methods, systems, and computer program products for generating service-access activities for workflow applications. In some embodiments, a generated activity is configured to access an external service. An editor receives user input dragging and dropping a generated activity onto a workflow designer surface. The generated activity is for inclusion in a workflow. The editor receives additional user input defining operation input parameters and operation output parameters for invoking the external service.

Automatically and without further user input, the generated activity is configured to access the external service in response to the additional user input. Metadata defining the operation of the external service is accessed. A configuration file is generated in accordance with the retrieved metadata. The configuration file describes at least the address of the external service, how an endpoint for the external service is to be used, and how to access the external service.

A message type is generated to fit data format of the external service in accordance with the retrieved metadata. Message type generation includes, generating input expressions to convert input parameters from the generated activity into the message format for inclusion in send messages sent to the external service. Message type generation also includes, generating output expressions to convert reply messages in the message format received from the external service into output parameters for the generated activity. Service activities are corresponding to service operations of the external service are generated based on the generated message type.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

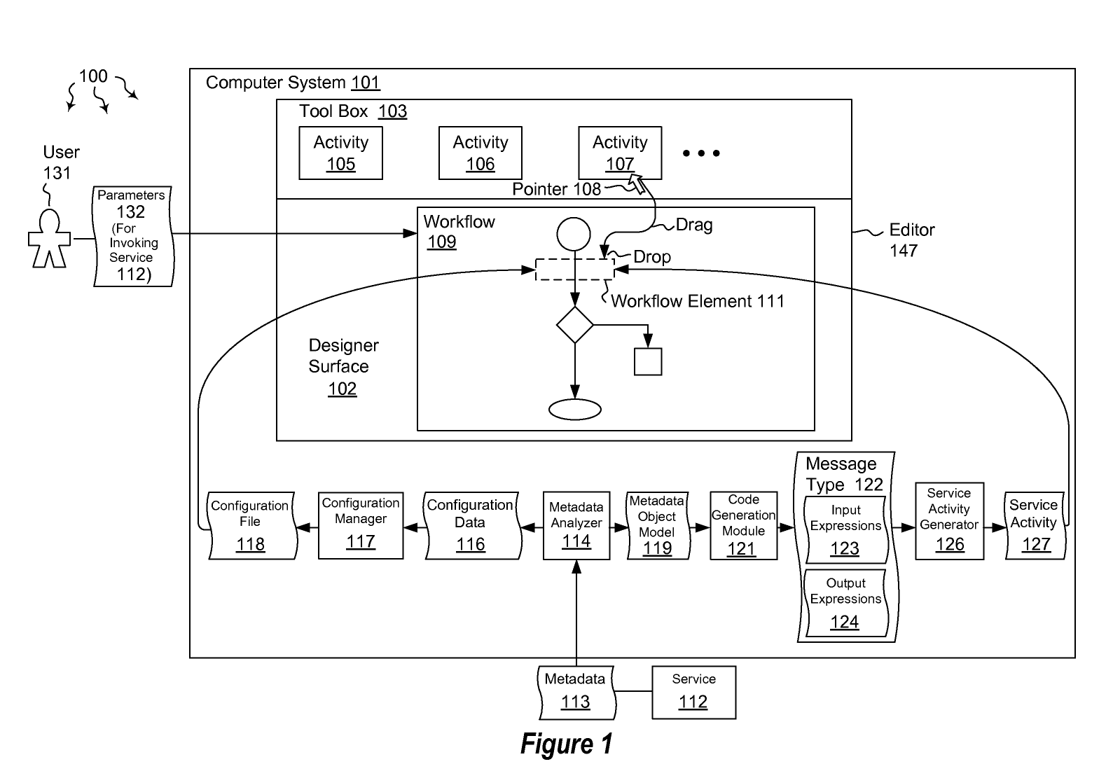

FIG. 1 illustrates an example computer architecture 100 that facilitates generating service-access activities for workflow applications. Referring to FIG. 1, computer architecture 100 includes computer system 101 and service 112. Each of the depicted computer systems and components is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

As depicted, computer system 101 includes editor 147, metadata analyzer 114, configuration manager 117, code generation module 121, and service activity generator 126.

Generally, editor 147 is a visual editor configured to create and edit workflows. Editor 147 includes toolbox 103 and designer surface 102. Toolbox 103 includes one or more activities, such as, for example, activities 105, 106, and 107, that can be dragged and dropped into workflows on designer surface 102.

Metadata analyzer 114 is configured to access and analyze metadata for service external to computer system 101. The external service can be a service that a workflow (e.g., being edited in designer surface 102) is to interoperate with to perform one or more functions. Metadata analyzer 114 can separate service metadata in to a plurality of different portions, including configuration data and an object model.

Configuration manager 117 is configured to receive configuration data and generate a configuration file based on the configuration data. The configuration file can then be used to configure a workflow element for compatibility with a service.

Code generation module 121 is configured to receive an object model and generate a message type based on the object model. A message type can include input expressions and output expressions. Input expressions can be used to convert input parameters from a generated activity into the message format for messages format for messages sent to the external service. Output expressions can be used to convert reply messages in the message format from the external service into output parameters for the generated activity.

Service activity generator 126 is configured to receive a message type and generate services activities. A workflow element can then used the service activities to compatibly communicate with the external service.

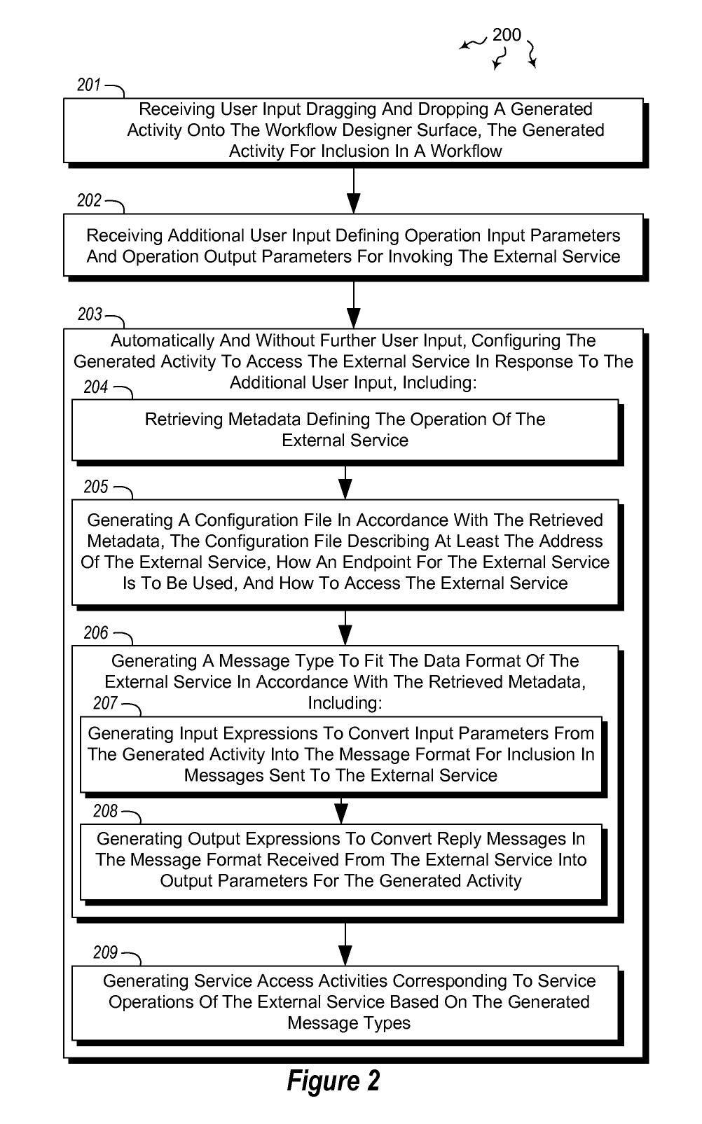

FIG. 2 illustrates a flow chart of an example method 200 for generating service-access activities for workflow applications. Method 200 will be described with respect to the components and data in computer architecture 100.

Method 200 includes an act of receiving user input dragging and dropping a generated activity onto the workflow designer surface, the generated activity for inclusion in a workflow (act 201). For example, editor 147 can receive user input dragging and dropping activity 107 into workflow 109. Dropping activity 107 into workflow 109 causes workflow element 111 to be inserted into workflow 109. Alternately, a “one-click” selection can be used. For example, a single click (e.g., of a mouse button) can be used to add activity 107 to workflow 109.

Method 200 includes an act of receiving additional user input defining operation input parameters and operation output parameters for invoking the external service (act 202). For example, user 131 can send parameters 132 (for invoking service 112) to editor 147. Editor 147 can receive parameters 132.

Method 200 includes an act of automatically and without further user input, configuring the generated activity to access the external service in response to the additional user input (act 203). For example, computer system 101 can automatically configure workflow element 111 to access service 112 in response to parameters 132.

Act 203 includes retrieving metadata defining the operation of the external service (act 204). For example, metadata analyzer 114 can retrieve metadata 113. Metadata 113 can define one or more aspects of how service 112 operates. Metadata 113 can be retrieved, for example, from a Web Services Description Language (“WSDL”) file or a Metadata Exchange (“MEX”) endpoint.

Act 203 includes an act of generating a configuration file in accordance with the retrieved metadata, the configuration file describing at least the address of the external service, how an endpoint for the external service is to be used, and how to access the external service (act 205). For example, upon analyzing metadata 113, metadata analyzer 114, can output configuration data 116. Configuration manager 117 can subsequently access configuration data 116. Configuration manager 117 can generate configuration file 118 from configuration data 116. Configuration file 118 describes at least an address for accessing service 112, how an endpoint for service 112 is to be used, and how to access service 112.

Act 203 includes an act of generating a message type to fit the data format of the external service in accordance with the retrieved metadata (act 206). For example, upon analyzing metadata 113, metadata analyzer 114, can output metadata object model 119. Code generation module 121 can subsequently access object model 119. Code generation module 121 can generate message type 122 from object model 119. In some embodiments, message type 122 is a .Net class.

Act 206 includes an act of generating input expressions to convert input parameters from the generated activity into the message format for inclusion in messages sent to the external service (act 207). For example, code generation module 121 can generate input expressions 123. Input expressions 123 can be used to convert input parameters from workflow element 111 into message type 122. The converted parameters can then be included in messages sent to server 113. Act 206 includes an act of generating output expressions to convert reply messages in the message format from the external service into output parameters for the generated activity (act 208). For example, code generation module 121 can generate output expressions 124. Output expressions 124 can be used to convert reply messages from service 112 (in message type 122) into output parameters. The output parameters can then be utilized at workflow element 111.

In some embodiments, input expressions and/or output expressions are Visual Basic (“VB”) expressions that can be serialized. Thus, auto generation can be used to bridge the gap between parameters (e.g., a developer understandable service contract) and an actual message format on the wire.

Act 203 can include an act of generating service access activities corresponding to service operations of the external service based on the generated message type (act 209). For example, service activity generator 126 can generate service activities 127 based on message type 122. Service activities 127 correspond to service operations of service 112.

Service access activities can expose configurable data that a workflow developer can subsequently use to configure a workflow element to interoperate with a service. Exposed configurable data can include input and output parameters. In some embodiments, generating service access activities includes generating declarative XAML files. XAML files (which make application as data) provide flexibility for deployment, versioning, tooling, transformation, and interchange.

Generated service activities can pre-configure and encapsulate one or more of operation name, service contract name, data content format, and operation actions. Pre-configuration and encapsulation provides at least some abstraction from a remote procedure call to call a service and also protects settings from corruption over time. Generated service activities can include Send, ReceiveReply, and Assign activities. Send and ReceiveReply activities can be composed in a pair to correlate the Send and ReceiveReply with one another.

As such, editor 147 can use both configuration file 118 and service activities 127 to automatically configure workflow element 111 for compatible interoperation with service 112. Thus, data from other workflow elements in workflow 109 can be sent to service 112 (through workflow element 111). Likewise, data received from service 112 can be sent to other workflow elements in workflow 109 (through workflow element 111).

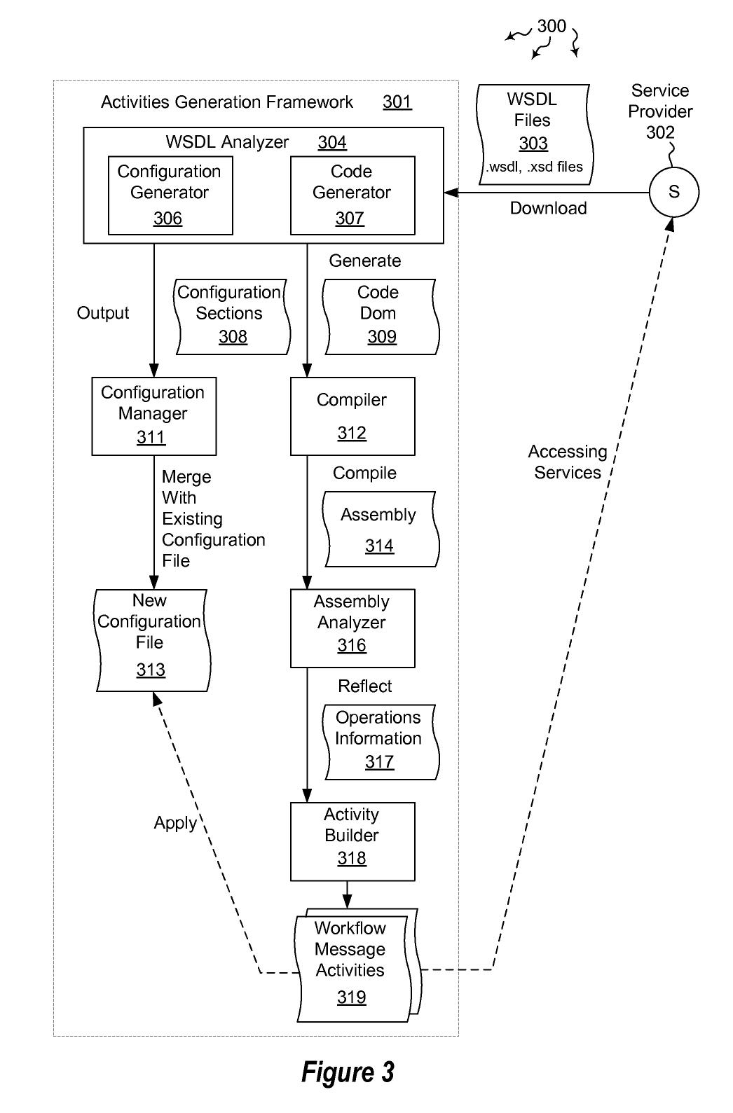

FIG. 3 illustrates example computer architecture 300 that facilitates generating service-access activities for workflow applications. As depicted, computer architecture 300 includes activities generation framework 301 and service provider 302. Activities generation framework 301 further includes WSDL analyzer 304, containing configuration generator 306 and code generator 307, configuration manager 311, compiler 312, assembly analyzer 316, and activity builder 318.

Activities generation framework 301 can download WSDL files 303 from service provider 302. WSDL analyzer 304 can analyzer WSDL files 303. Configuration generator 306 can output configuration sections 308. Configuration manager 311 can merge configuration sections 308 with an existing configuration file to generate new configuration file 313.

Code generator 307 can generate code Document Object Model (“DOM”) 309. Computer 312 can compile code DOM 309 into assembly 314. Assembly analyzer 316 can reflect over assembly 314 to identify operations information 317. Activity builder 318 can used operations information 317 to output workflow message activities 319.

Workflow message activities 319 can be applied to new configuration file 313 and used to access service provider 302.

Accordingly, embodiments of the invention automatically generate service-access activities based on (e.g., Web) service metadata. One-click generation, together with encapsulation of configuration complexity, helps developers improve productivity and reduce the likelihood of making mistakes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, the computer system also including a workflow designer surface, a method for configuring a generated activity to access an external service, the method comprising:
an act of receiving user input dragging and dropping a generated activity onto the workflow designer surface, the generated activity for inclusion in a workflow;
an act of receiving additional user input defining operation input parameters and operation output parameters for invoking the external service; and
an act of the processor, automatically and without further user input, configuring the generated activity to access the external service in response to the additional user input, including:
an act of retrieving metadata defining the operation of the external service;
an act of generating a configuration file in accordance with the retrieved metadata, the configuration file describing at least the address of the external service, how an endpoint for the external service is to be used, and how to access the external service;
an act of generating a message type to fit the data format of the external service in accordance with the retrieved metadata, including:
an act of generating input expressions to convert input parameters from the generated activity into the message format for inclusion in messages sent to the external service; and
an act of generating output expressions to convert reply messages in the message format from the external service into output parameters for the generated activity; and
an act of generating service access activities corresponding to service operations of the external service based on the generated message type.

2. The method as recited in claim 1, wherein the act of retrieving metadata defining the operation of the external service comprises an act of retrieving metadata from one of a Web Services Description Language (“WSDL”) file or a Metadata Exchange (“MEX”) endpoint.

3. The method as recited in claim 1, wherein one or more of the input expressions and output expressions are Visual Basic (“VB”) expressions.

4. The method as recited in claim 1, wherein the act of generating service access activities comprises an act of generating declarative XAML files.

5. The method as recited in claim 1, wherein the act of generating service access activities comprises an act of generating service access activities that expose configurable data a workflow developer can use to configure the generated activity for accessing the external services.

6. The method as recited in claim 5, wherein the act of generating service access activities that expose configurable data comprises an act of generating service access activities that expose configurable data, the configurable data selected from among input parameters and output parameters.

7. The method as recited in claim 1, wherein the act of generating service access activities comprises an act of generating service access activities that pre-configure and encapsulate one or more of operation name, service contract name, data content format, and operation actions.

8. The method as recited in claim 1, wherein the act of generating service access activities comprises an act of generating service access activities that composes Send, ReceiveReply, and Assign activities.

9. The method as recited in claim 1, wherein the act of generating service access activities comprises an act of generating service access activities that compose a Send and ReceiveReply together in a pair to correlate the Send and ReceiveReply with one another.

10. A computer program product for use at a computer system, the computer system also including a workflow designer surface, the computer program product of implementing a method for configuring a generated activity to access an external service, the computer program product comprising one or more computer-readable media having stored thereon computer-executable instructions that, when executed at a processor, cause the computer system to perform the method, including the following:
receive user input dragging and dropping a generated activity onto the workflow designer surface, the generated activity for inclusion in a workflow;
receive additional user input defining operation input parameters and operation output parameters for invoking the external service; and
configure the generated activity to access the external service in response to the additional user input, including:
retrieving metadata defining the operation of the external service;
generating a configuration file in accordance with the retrieved metadata, the configuration file describing at least the address of the external service, how an endpoint for the external service is to be used, and how to access the external service;
generating a message type to fit the data format of the external service in accordance with the retrieved metadata, including:
generating input expressions to convert input parameters from the generated activity into the message format for inclusion in messages sent to the external service; and
generating output expressions to convert reply messages in the message format from the external service into output parameters for the generated activity; and
generating service access activities corresponding to service operations of the external service based on the generated message type.

11. The computer program product as recited in claim 10, wherein computer-executable instructions that, when executed, cause the computer system to retrieve metadata defining the operation of the external service comprise computer-executable instructions that, when executed, cause the computer system to retrieve metadata from one of a Web Services Description Language (“WSDL”) file or a Metadata Exchange (“MEX”) endpoint.

12. The computer program product as recited in claim 10, wherein computer-executable instructions that, when executed, cause the computer system to generate service access activities comprise computer-executable instructions that, when executed, cause the computer system to generate declarative XAML files.

13. The computer program product as recited in claim 10, wherein computer-executable instructions that, when executed, cause the computer system to generate service access activities comprise wherein computer-executable instructions that, when executed, cause the computer system to generate service access activities that expose configurable data a workflow developer can use to configure the generated activity for accessing the external services.

14. The computer program product as recited in claim 13, wherein computer-executable instructions that, when executed, cause the computer system to generate service access activities that expose configurable data comprise wherein computer-executable instructions that, when executed, cause the computer system to generate service access activities that expose configurable data, the configurable data selected from among input parameters and output parameters.

15. The computer program product as recited in claim 10, wherein computer-executable instructions that, when executed, cause the computer system to generate service access activities comprise computer-executable instructions that, when executed, cause the computer system to generate service access activities that pre-configure and encapsulate one or more of operation name, service contract name, data content format, and operation actions.

16. The computer program product as recited in claim 10, wherein computer-executable instructions that, when executed, cause the computer system to generate service access activities comprise computer-executable instructions that, when executed, cause the computer system to generate service access activities that composes Send, ReceiveReply, and Assign activities.

17. The computer program product as recited in claim 10, wherein computer-executable instructions that, when executed, cause the computer system to generate service access activities comprise computer-executable instructions that, when executed, cause the computer system to generate service access activities that compose a Send and ReceiveReply together in a pair to correlate the Send and ReceiveReply with one another.

18. A system, the system comprising:
one or more processors;
system memory;
one or more storage media having stored thereon computer-executable instructions representing a visual editor and an activities generation framework, the activities generation framework including a Web Services Description Language (“WSDL”) analyzer, a configuration manager, a compiler, an assembly analyzer, and an activity builder, wherein the visual editor is configured to:
receive one-click input for adding an activity to a workflow;
wherein the Web Services Description Language (“WSDL”) analyzer is configured to:
access metadata for a service from a WSDL file in response to detecting one-click input for adding an activity to a workflow; and
analyze the metadata to identify one or more configuration sections and a code Document Object Model (“DOM”);
wherein the configuration manager is configured to:
receive one or more configuration sections; and
generate a new configuration file by merging the one or more configuration sections with an existing configuration file;
wherein the compiler is configured to:
receive a code DOM; and
compile an assembly from the code DOM;
wherein the assembly analyzer is configured to:
receive an assembly; and
reflect over the assembly to identify operations information for the service; and
wherein the activity builder is configured to:
receive operations information; and
output workflow message activities from the operations information.

19. The system of claim 18, wherein the activities generation framework is further configured to apply workflow message activities to the new configuration file.

20. The system of claim 18, wherein the Web Services Description Language (“WSDL”) analyzer includes a configuration generator for outputting configuration sections and a code generation for generating code DOMs.
